(19) United States
(12) Patent Application Publication
(10) Pub. No.: US 2024/0178683 A1
(43) Pub. Date: May 30, 2024

(54) MODULAR PORTABLE POWER SYSTEM FOR SMALL APPLIANCE APPLICATIONS

(71) Applicant: Bollinger Industries, Inc., Roanoke, TX (US)

(72) Inventors: Mike Silva, Hartford, CT (US); Troy Starkey, Hartford, CT (US); Fan Ding, Hartford, CT (US)

(21) Appl. No.: 18/522,928

(22) Filed: Nov. 29, 2023

Related U.S. Application Data
(60) Provisional application No. 63/385,285, filed on Nov. 29, 2022.

(51) Int. Cl. H02J 7/00; H02J 50/10; H02J 50/90

(52) U.S. Cl. CPC H02J 7/0044; H02J 7/0063; H02J 50/10; H02J 50/90; H02J 7/0049

(57) ABSTRACT

A portable power charger is provided for charging a small appliance or an electronic device from a rechargeable battery internally disposed within the charger. An attachment system is also provided for connecting the electronic device to the portable charger and maintaining the connection during charging, whether by wireless or direct charging means. The attachment system ensures that respective wireless transmission components in the portable charger and the electronic device, where available, are properly aligned for optimal and efficient wireless charging. The alignment system can comprise structural feature formed in the charger housing, such as grooves or projections formed on the charger housing to physically attach the portable charger to the small appliance or the electronic device, whereby the connection can be maintained during the exchange of a charge from the portable power charger to the small appliance or electronic device.

### STATEMENT OF RELATED INVENTIONS

This application is a U.S. Nonprovisional application which claims the benefit of U.S. Provisional Application No. 63/385,285, filed Nov. 29, 2022, and is hereby incorporated by reference in its entirety.

### FIELD OF INVENTION

The present invention generally relates to a power charging apparatus and system, and more particularly relates to a portable power charger and an associated system for attaching said portable power charger to small appliances for charging and operation, and whereby the portable power charger may also be used independently for attachment to mobile electronic devices for charging purposes.

### BACKGROUND

This section is intended to provide a background or context. The description may include concepts that may be pursued, but have not necessarily been previously conceived or pursued. Unless indicated otherwise, what is described in this section is not deemed prior art to the description and claims and is not admitted to be prior art by inclusion in this section.

Present day consumers typically own several electronic devices specifically designed for portability and on-the-go use, including, for example, a mobile phone or smart phone, a portable music player like an iPod® or an MP3 player, a tablet, a portable gaming unit, a camera, and the like. Each of these devices requires frequent recharging. Such electronic devices typically utilize a cable for connecting the device to a power source, such as a wall outlet, a car charger, an airplane charger, or a computer. However, a separate cable is usually required for each power source. Moreover, different electronic devices often utilize different connection ports and interfaces such that a single charging cable is not compatible with multiple devices. Accordingly, a tech-savvy consumer, with several electronic devices, will usually have multiple charging cables to keep track of. Even then, the consumer may be without sufficient power to recharge a phone due to bad weather or a power outage, or may not always be in a place where a power source is readily available, or even if so, may not have the appropriate cable or adapter available to use with a particular power source.

With traditional power sources, such as those noted above, it is often difficult to charge multiple devices at the same time, especially where each device requires a separate charging cable. For example, a car charger port may only handle a single cable at a time. Adaptor devices are available on the market for connecting multiple devices to a power source at the same time—for example, a two-to-one or three-to-one car charger splitter. However, such adapters are often only compatible with certain interfaces. Moreover, such adapters are separate from portable power sources and tend to be bulky.

Similarly, connection interface attachments are also available for adapting a charging cable for use with a variety of devices for recharging from a power source, each requiring a different interface connection. However, such attachments are usually separate small pieces, and therefore difficult to keep track of when not in use. Further, use of such attachments does not solve the problem presented by the need to charge multiple devices at the same time, from the same power source, as oftentimes, only one attachment can be used with a charging cable at a time.

Portable power chargers exist that permit recharging of electronic devices when a standard power source is not readily available. For example, portable power chargers are illustrated and described in U.S. Pat. No. 9,973,016, which is incorporated by reference in its entirety. Some existing power charger devices usually cannot charge multiple devices at the same time, either due to limited capacity or connectivity options. Even if multiple devices may be attached to the power charger at the same time, the charger may prioritize how the devices are recharged—i.e., it will charge one device first and then the second, and so on. However, this approach takes a long time to recharge all devices and risks not having sufficient charge remaining in the charger for fully charging the second device.

Wireless power chargers have also been introduced to the market, especially for mobile electronic devices, and have provided additional approaches to recharging portable electronic devices. Such wireless power transmission devices have been developed in connection with wireless charging standardization efforts, including by the Wireless Power Consortium (WPC), which have led to the adoption of devices that permit recharging of electronic devices without the use of separate chargers for each device. More particularly, the WPC has introduced the Qi wireless charging standard. Qi, which translates to “vital energy,” takes its name from the Chinese concept of intangible flow of power and utilizes magnetic coil induction to transmit a charge from a transmitter to a receiver via a magnetic field.

Various drawbacks of prior art wireless power chargers have been identified. For example, such wireless chargers are not easily portable and require direct connection to an external power source for operation. Such external power sources are often not readily available, which makes the charger useless for on-the-go use.

There is also a general need for portable power chargers with improved functionality—specifically, that can be used to charge more than personal electronic devices. In this regard, a portable power charger could be used to charge small appliances, including but not limited to vacuum cleaners, air compressors, car jacks, portable utility lights, coolers, and power tools. Heretofore, power packs have been created for 12V power tools, including modular systems where a single battery pack can be used with a variety of hand-held power tools. In general, however, such power packs were designated for use only with specific power tools and had no functionality separate from use with the power tools. Thus, the power pack could only be used as a source of power when connected to a power tool. Additionally, as power tool applications grew over time, many tool vendors required stepping up the battery pack voltages to meet higher demand for certain applications. With the increased power, the availability of multi-functional modular power chargers became more limited, as battery packs with increased voltage capacity (e.g., 18 v or higher) were generally designed for a specific tool and again could only be used with that specific tool for the limited function of charging that tool.

In view of the foregoing, there is a need for a charger system that can be used to charge a variety of electronic devices, including but not limited to smart phones, mobile phones, data tablets, music players, cameras, camcorders, gaming units, e-books, Bluetooth® headsets and carpieces, GPS devices, and the like, either individually or simultaneously in various combinations, as well as small appliances, such as vacuum cleaners, air compressors, car jacks, utility lights, coolers, power tools, and the like. Additionally, there is a need for a power charger that is portable, has a compact size, is easily attachable to an electronic device or small appliance for easy carry and use with the electronic device or small appliance, and further is easy to use in various conditions and locations to charge one or more electronic devices simultaneously, including but not limited to in a house or office, a car or an airplane, as well as on-the-go, or power a small appliance for normal operation, without compromising operation and performance. Further, there is a need for a portable charger that is easily attachable to and detachable from an electronic device or small appliance allowing for convenient and hands-free charge and carry. Still further, there is a need for an attachment system for such a portable charger that can ensure proper alignment between the charger and an electronic device or small appliance in need of a recharge in order for the electronic device or small appliance to be wireless recharged or otherwise powered from the portable charger. Still further, there is a need for a portable charger that can be recharged from an external power source or from a wireless power transmission device, providing increase flexibility and convenience of use for the portable charger. Still further, there is a need for a portable charger that can recharge its internal battery from an external power source or a wireless charging device at the same time as an electronic device or small appliance connected to the charger, either directly or wirelessly, is being recharged or otherwise powered by or via the charger unit. Still further, there is a need for a portable charger unit in a compact size that has increased functionality for a user requiring a portable source of power without compromising its ability to successfully and consistently connect to and charge electronic devices, either directly or wirelessly.

Accordingly, it is a general object of the present invention to provide a portable charger system that improves upon conventional power chargers currently on the market and that overcomes the problems and drawbacks associated with such prior art chargers.

### SUMMARY

The below summary is merely representative and non-limiting.

The above problems are overcome, and other advantages may be realized, by the use of the embodiments.

In accordance with the present invention, a portable power charger is provided for charging one or more portable electronic devices or powering a variety of small appliances. In general, a portable power charger includes a charger housing having a rechargeable battery unit disposed therein for connecting to and recharging one or more electronic devices, as necessary, and may also include wireless power transmission components, such as a transmitter and a receiver, for recharging the charger as well as electronic devices and small appliances via wireless power transmission methods. The portable power charger may also include at least one power connection port for directly connecting the portable power charger with an external power source, or at least one electronic device or small appliance, or both. Similarly, the portable power charger may also include at least one connector cable interface for directly connecting the portable power charger with an external power source, or at least one electronic device or small appliance, or both.

In embodiments of the present invention, the portable power charger can include a wireless transmitter operatively connected to the internal rechargeable battery for transmitting a power charge to an electronic device having a wireless receiver. The portable power charger may further include a wireless receiver operatively connected to the internal battery for receiving a power charge from a power source having a wireless transmitter. In embodiments of the portable power charger including both a wireless transmitter and a wireless receiver, the portable power charger can both be charged wirelessly, for example, when placed on a wireless power transmission device (e.g., wireless charging mat), and charge other devices wirelessly, for example, when a device is placed on the charger housing or the charger housing is mechanically engaged with a device so that a wireless charge can pass from the portable power charger to the device.

In alternate embodiments of the present invention, the portable power charger can simply be designed for direct charging of electronic devices and small appliances—for example, through connection via a power connection port provided on the charger housing or via a connector cable provided with the portable power charger. Such a connector cable can be storable within a storage cavity formed in the charger housing where the connector cable is stored when not in use and from which the connector cable can be flexed out for connection to an electronic device or small appliance in need of a charge from the portable power charger or alternately to an external power source for recharging the internal battery unit of the portable power charger. Further, the connector cable can be fully removed for use with a power connection port provided on the charger housing, or operatively connected with the internal battery unit through the storage cavity. Still further, a number of interchangeable connector cables can be provided with the portable power charger, each adapted to be stored in a common storage cavity, and changed out with one another as needed.

In addition, in accordance with an aspect of the present invention, the portable power charger includes an attachment system comprising mechanical attachment means for attaching the portable power charger to an electronic device or small appliance, and vice versa, so that the portable power charger and the electronic device or small appliance can be physically connected together during charging, and more preferably, be properly aligned relative to one another for efficient wireless transmission, if desired. Additionally, the attachment of the portable power charger directly to the electronic device or small appliance permits the charger and electronic device/small appliance to be carried or used by the user as one unit, while also facilitating and improving the charging of the electronic device/small appliance, either by wireless charging, or by direct charging connection, in accordance with embodiments of the present invention. Still further, the attachment means ensure proper alignment of the electronic device/small appliance with the portable power charger for wireless Qi charging, and also maintain such alignment during the charging process—for example, a transmitter induction coil in the charger is aligned with a receiver induction coil in the electronic device to ensure proper and efficient wireless connection therebetween.

In an embodiment of the present invention, the portable power charger is attachable to an electronic device via first attachment means comprising a structural feature or features (such as grooves, recesses, ribs, or projections) formed onto or into the charger housing that interact and engage a complementary shaped structural feature or features (such as projections or ribs on the one hand, and grooves or recesses on the other hand) formed into an electronic device, a small appliance, or an adapter configured to be mounted onto the charger and hold an electronic device/small appliance in place adjacent to the power charger, and more preferably hold said device/appliance in an aligned position optimal for wireless charging from the power charger to the device/appliance.

Alternative attachment means that may be used with the portable power chargers in accordance with the present invention may comprise magnets, an adhesive patch or a suction cup that, when pressed against the surface of an electronic device, attaches the electronic device to the charger and allows for hands-fee carry and charge. The magnet, adhesive, or sticky, patch and suction cup options allow the portable power charger to remain stuck to the electronic device while charging but also allows for seamless removal when the charge is completed by pulling the portable power charger apart from the electronic device.

In accordance with embodiments of the present invention, the portable power charger comprises a charger housing with a rechargeable internal battery disposed therein. The internal battery is operatively connected with the wireless transmitter and receiver for charging other electronic devices from the internal battery via the wireless transmitter or for relaying an electrical charge from an external power source for recharging the internal battery when the portable power charger is connected to the power source via the wireless receiver. The charger unit is portable as a result of the small size of the housing. Despite the small size of the unit, the power capacity is very high so that the charger can easily operate a standard 12 V small appliance, such as a hand-held vacuum cleaner, and air compressor, utility lights, a cooler, or hand-held power tools, or even accommodate multiple electronic devices (e.g., a smart phone, a smart watch, and a tablet) at the same time.

Additionally, the portable power charger may include one or more power connection interfaces for directly connecting the portable charger with an external power source, or at least one electronic device or small appliance, or both. For example, the rechargeable internal battery disposed within the charger housing is operatively connected with a power connection interface (such as, a port or a charging cable) for relaying an electrical charge from an external power source for recharging the internal battery when the portable power charger is connected to the power source via the power connection interface (acting as a power input) and/or for charging other electronic devices/small appliance from the internal battery via the power connection interface (acting as a power output).

In embodiments of the present invention, a power connection interface can comprise a female connection port adapted for receiving a complementary male connection interface of a standard charging cable, which connects at an opposite end to a portable electronic device. In other embodiments, a power connection interface can include a charging cable attached to or provided with the charger housing and preferably stored within a storage cavity in the charger housing when not in use. Such charging cable can even be removable and replaceable with another charging cable so as to change the connection interfaces, as necessary, to coordinate with particular electronic devices. In preferred embodiments of the present invention, the portable power charger includes both wireless charging capabilities, and direct charging connectivity.

In accordance with alternate embodiments of the present invention, the portable power charger comprises a charger housing with a rechargeable internal battery disposed therein. The internal battery is operatively connected with one or more power connection interfaces for directly connecting the portable charger with an external power source, or at least one electronic device or small appliance, or both. For example, the rechargeable internal battery disposed within the charger housing is operatively connected with a connector cable storable in a storage cavity formed in the charger housing for storing the connector cable when not in use and from which the connector cable can be flexed for connection with an electronic device in need of a charge from the internal battery unit of the portable power charger or an external power source for recharging the portable power charger. More preferably, the connector cable is removable and interchangeable with like-shaped connector cables, each with a different connection interface so that the portable power charger can be connected to various electronic devices. Additionally, the portable power charger is attachable to an electronic device via attachment means comprising grooves or projections formed on the charger housing that interact and engage with a small appliance or an adapter that can hold and position an electronic device in position relative to the charger for charging, and allows for hands-fee carry and charge. The adapter, as held by the grooves or projections on the portable charger, allows the electronic device to be “attached” to the portable power charger while charging but also allows for seamless removal when the charge is completed by sliding the electronic device out of the adapter, or simply removing the adapter from the portable power charger.

In various embodiments of the present invention, the portable power charger may further comprise a controller or processing unit, which can control wireless and direct connectivity with the portable power charger, keep track of the capacity level of the rechargeable battery, store data or provide a conduit means by which data can be exchanged between electronic devices, such as between a smart phone and a computer.

These and other objects, features and advantages of the present invention will become apparent in light of the detailed description of embodiments thereof, as illustrated in the accompanying drawings.

### BRIEF DESCRIPTION OF THE DRAWINGS

Aspects of the described embodiments are more evident in the following description, when read in conjunction with the attached Figures.

FIG. 1 shows a front, top perspective view of a first embodiment of a portable power charger.

FIG. 2 shows a perspective view of the portable power charger of FIG. 1 attached to a hand-held vacuum cleaner.

FIG. 3 shows a perspective view of the portable power charger of FIG. 1 attached to an air compressor pump.

FIG. 4 shows a perspective view of the portable power charger of FIG. 1 attached to a portable utility light.

FIG. 5 shows a perspective view of a second embodiment of a portable power charger.

FIG. 6 shows another perspective view of the portable power charger of FIG. 5.

FIG. 7 shows a perspective view of the portable power charger of FIG. 5 attached to an air compressor pump.

FIG. 8 shows a perspective view of a third embodiment of a portable power charger.

FIG. 9 shows a perspective view of a fourth embodiment of a portable power charger.

FIG. 10 shows a perspective view of the portable power charger of FIG. 9 attached to various charging devices.

FIG. 11 shows a simplified block diagram of internal components of a fifth embodiment of a portable power charger.

### DETAILED DESCRIPTION

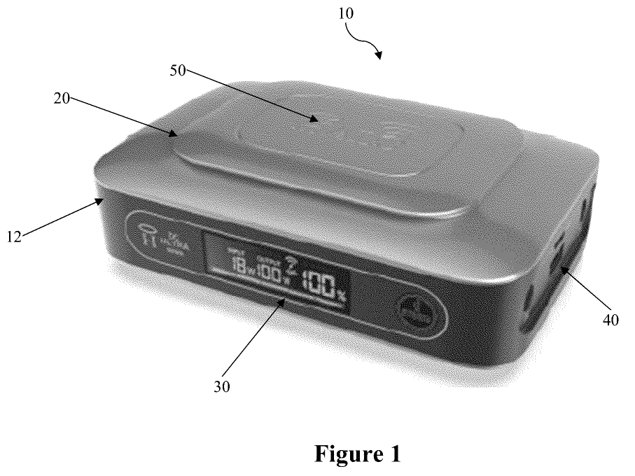

A portable power charger in accordance with an embodiment is illustrated in FIG. 1, and generally designated as reference numeral 10. The portable power charger 10 generally includes a charger housing 12 having a rechargeable battery unit (not shown) internally disposed therein. The power charger 10 is designed for portability and convenient on-the-go use to recharge one or more mobile electronic devices and is designed to be attachable to an electronic device or a small appliance via an attachment system comprising at attachment means provided on or in the charger housing 12. In embodiments of the present invention, the charger attachment means allow for hands free use, carry and charge of the electronic device or small appliance, while also allowing for easy detachment from the electronic device or small appliance, once attached and as needed.

The portable power charger 10 is also designed for easy and flexible recharging of the internal battery from a variety of power sources so that it can be easily charged up to have sufficient battery capacity when it is needed to recharge a portable electronic device. Preferably, the rechargeable battery unit of the portable power charger 10 is capable of being recharged in a variety of manners, including via direct connection, such as ports 40, and via wireless connection, such as wireless charging interface. For example, to charge the battery unit, the charger 10 may be connected with an external power source via a power input connector cable interface provided with the charger 10; via direct connection with an external power source via a separate connector cable that engages a power connection port interface 40 provided on the charger housing 12; or via wireless power transmission means. A portable power charger 10 in accordance with the present invention can include any or all of these recharging features in various combinations without departing from the principles and spirit of the present invention.

Similarly, the portable power charger 10 can be used to power a small appliance or to recharge one or more electronic devices in a variety of manners, including via direct connection and via wireless connection. For example, to use the portable charger 10 to power a small appliance or recharge an electronic device, the charger 10 may be connected with a small appliance or an electronic device via a power output connector cable interface provided with the charger 10; via direct connection with the small appliance or the electronic device via a separate connector cable that engages a power connection port interface 40 provided on the charger housing 12; or via wireless power transmission means. A portable power charger 10 in accordance with the present invention can include any or all of these recharging features in various combinations without departing from the principles and spirit of the present invention.

Referring to the embodiment illustrated in FIG. 1, the portable power charger 10 of the present invention has the capability of charging other devices or being recharged itself via wireless transmissions, or via direct connections, either using connector cables provided with and stored in the charger housing 12, or via separate connector cables attachable to the charger 10 via power connection ports 40 provided on the charger housing 12. In this regard, the portable charger 10 can be used on-the-go to charge one or more electronic devices by various means and combination of means.

As noted, the portable power charger 10 of the illustrated embodiments includes the capability of charging electronic devices and small appliances via wireless power transmission. In this regard, the portable power charger 10 includes a wireless transmitter for transmitting a charge to an electronic device or small appliance. In alternative or additional embodiments, the portable power charger 10 may also include a wireless receiver for receiving a charge from a wireless charging mat or power transmitting device allowing the charger unit 10 to be recharged either wirelessly or via direct connection to an external power source, and at the same time be connected to multiple electronic devices by both wireless and direct connection means such as disclosed in U.S. Pat. No. 9,318,915, incorporated herein by reference.

The wireless transmitter of the portable power charger 10 generally comprises a magnetic induction coil (not shown) operatively connected to the internal battery unit. Referring to FIG. 1, a wireless transmission area 50 generally aligned with the transmitter coil is illustrated on the top face of the charger housing 12. When an electronic device or a small appliance that includes a wireless receiver is aligned with the wireless transmission area 50, a magnetic field generated by the transmitter is transmitted to the receiver of the electronic device or small appliance, where a voltage is induced to power the electronic device/small appliance or recharge its internal battery, if available. In this regard, the designated wireless transmission area 50 is preferably visible to the user or at least easily ascertained so as to facilitate proper alignment and wireless charging.

The portable power charger 10 may also include a display 30 in order to provide status information and other details. The display 30 can indicate the amount of power being supplied to the portable power charger 10 (Input), the amount of power being supplied by the portable power charger 10 (Output), the amount of energy battery power remaining, etc. In alternative embodiments, the display 30 may be shown as a status light or lights, such as a series of LEDs to indicate the amount of energy battery power remaining.

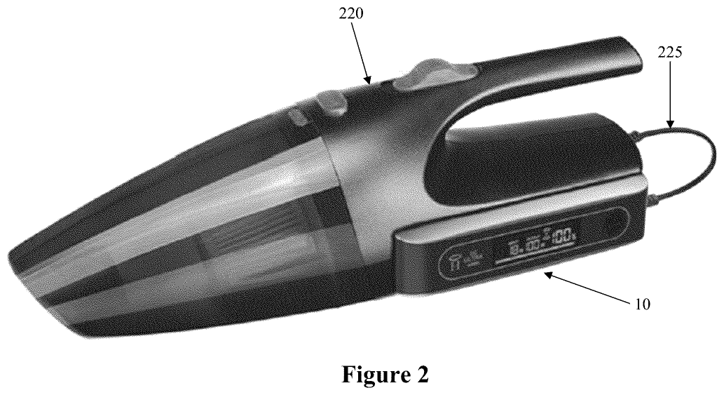

Referring again to FIG. 1, the portable power charger 10 includes an attachment system in accordance with the present invention on or disposed within and near a first outer surface of the charger housing 12. A first attachment means, generally designated as reference numeral 20, comprises a structural feature formed in or projecting outwardly from the charger housing. In FIG. 1, the first attachment means is illustrated as a projection with a circumferential groove or grooves. Such grooves are configured to mechanical interact with and engage complementary projections or ribs formed in an electronic device, a small appliance or an adapter designed to be attached to the portable power charger 10. For example, as illustrated in FIGS. 2-4, the power charger 10 is illustrated in use with a variety of small appliances whereby the first attachment means is used to engage complementary shaped attachment means on each of the appliances. For example, the body of the hand-held vacuum cleaner 220 illustrated in FIG. 2 includes a recess adapted to receive the projection on the top of the portable power charger 10 with ribs that slide within the circumferential groove. In preferred embodiments, the portable charger 10 would snap fit into place so it remains engaged with the appliance during use and there is no risk of the charger 10 becoming disengaged until the user affirmatively separates the charger 10 from the appliance.

Though the first attachment means are illustrated in the embodiment of FIG. 1 in the form of a projected structural feature with a groove, the charger 10 can include an attachment means of different designs, such as, for example, in form of projections or ribs projecting outwardly from the charger housing, without departing from the principles and spirit of the present invention. In such alternate designs, the appliance, or electronic device, or adapters that can be attached to the portable power charger 10 use complementary means for such engagement and attachment. Thus, as described above, complementary shaped attachment means allow for secure engagement between the portable power charger 10 and electronic device/small appliance. Where the portable power charger 10 utilizes projections, the devices can use complementary grooves for secure engagement between the portable power charger 10 and the devices without departing from the spirit and principles of the present invention.

In FIG. 2, the portable power charger 10 is connected to a hand-held vacuum cleaner 220 whereby the charger 10 is mechanically attached to the vacuum cleaner and essentially remains part of the vacuum cleaner during use. As illustrated, the power can be exchanged from the portable power charger 10 to the vacuum cleaner via a charging cable 225. In alternate embodiments, the power charge could be provided through wireless transmission means. Additionally, in operation, the power charger 10 could be simultaneously connected to an electronic device, such as a smart phone, for recharging even when the charger 10 is attached to the vacuum cleaner 220.

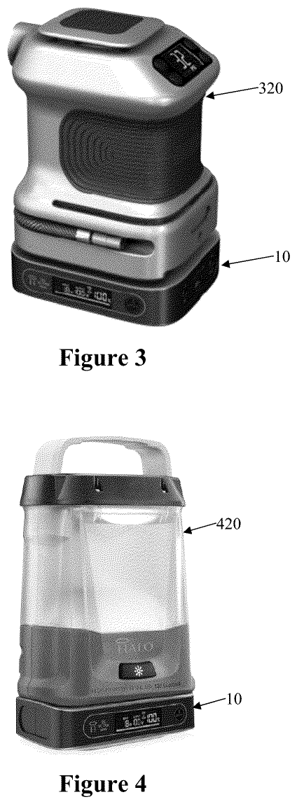

In FIG. 3, the portable power charger 10 is connected to an air compressor pump 320 using the mechanical attachment means. The power exchange between the power charger 10 and the air compressor could be via direct means (using a separate charging cable) or via wireless transmission means.

In FIG. 4, the portable power charger 10 is connected to a utility light 420 using the mechanical attachment means. The power exchange between the power charger 10 and the air compressor could be via direct means (using a separate charging cable) or via wireless transmission means.

In an alternate embodiment, the attachment system may also include a second attachment means comprising an arrangement of one or more magnets that interact with magnets or metallic pieces provided on or within the surface of the electronic device or small appliance. When the respective magnets are aligned, the portable charger 10 is attached to the electronic device/small appliance for wireless charging while also allowing for hands free use, carry and charge. In such embodiments of the present invention, said second attachment means comprises one or more magnets geometrically arranged on or within the first surface of the charger housing 12 in spaced apart relationship to one another. An electronic device or small appliance is provided with a complementary geometric arrangement of magnets in spaced apart relationship to one another, whereby interaction of the respective geometric arrangements on the portable charger 10 and the electronic device/small appliance ensure proper alignment of the charger 10 with the electronic device/small appliance for efficient power exchange or wireless charging. Use of the second attachment means also allows the portable power charger 10 to remain connected to the electronic device or small appliance while charging but also allows for seamless removal when the charge is completed.

Using a magnetic array on the portable charger 10, the power charger 10 can be attached to a variety of electronic devices and small appliances and ensure proper alignment for wireless charging regardless of the size and shape of the electronic device or small appliance, so long as the geometric array of magnets on said devices is properly positioned relative to the appropriate wireless transmission components therein.

The wireless charging capabilities of the portable power charger 10 in accordance with the present invention are beneficial in that they improve upon the convenience provided by wireless charging technology. For example, a small appliance can be powered or a portable electronic device can be recharged on-the-go even when the proper charging connector cable is not available. Indeed, the compact and portable design of the portable power charger 10 can permit charging of an electronic device in the user's pocket or purse simply by attaching the portable power charger 10 to the electronic device and ensuring that the electronic device is properly aligned with and proximate to the portable power charger 10. Additionally, once the portable power charger 10 is charged, a portable electronic device can be recharged without needing to be near an external power source, such as a wall socket, a car charger socket, an airplane charger socket, or a computer, which may not be readily available.

In operation, a portable power charger 10 in accordance with the present invention can be used in a variety of manners for recharging the power charger 10 itself, as well as for recharging portable electronic devices or powering small appliances. As a result of the compact size of the portable power charger 10 and the capacity of the built-in power bank, the portable power charger 10 can be used on-the-go to recharge a variety of electronic devices, including but not limited to smart phones, mobile phones, data tablets, music players, cameras, camcorders, gaming units, e-books, Bluetooth® headsets and carpieces, GPS devices, and the like, cither individually or simultaneously in various combinations. Additionally, as a result of the compact size of the portable power charger 10 and the capacity of the built-in power bank, the portable power charger 10 can be used to power a variety of small appliances, including but not limited to hand-held vacuum cleaners, air compressors and pumps, car jacks, utility lights, coolers, warmers, hand-held power tools, and the like.

In some embodiments, the rechargeable battery is preferably a Lithium-Ion battery that can be recharged by connecting the portable power charger 10 to an external power source, such as a computer, a wall socket, a car or an airplane power supply, or to a wireless power transmission device, such as a wireless charging mat. The rechargeable battery is disposed within the charger housing 12 and is operatively connected with any and all input and output connector cable interfaces, input and output connector port interfaces, and any and all wireless receivers and wireless transmitters for receiving a charge from an external power source and transmitting a charge to one or more electronic devices connected to the portable power charger 10, either wirelessly or through power output means.

The charger housing 12 encloses various electrical components (such as integrated circuit chips and other circuitry) to provide computing operations for the device. The integrated circuitry and other components may comprise a power supply (e.g., the internal rechargeable battery), a microprocessor and controller (e.g., a CPU), memory (e.g., ROM, RAM, flash), a circuit board, a hard drive, and/or various input/output (I/O) support circuitry. The electrical components may also include components for sending and receiving data and media (e.g., antenna, receiver, transmitter, transceiver, etc.), in addition to wireless transmission of power.

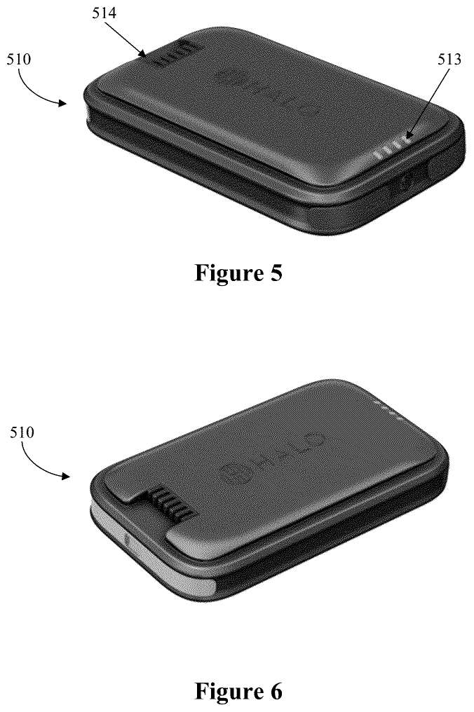

FIGS. 5-6 show perspective views of a second embodiment of a portable power charger 510. The portable power charger 510 includes series of LEDs 513 to indicate the amount of energy battery power remaining. The LEDs 513 may also be configured to change color and/or flash to indicate various status conditions, e.g., flashing red when below 10% battery power, showing blue when charging, etc. The portable power charger 510 also includes power connection ports 514 which may be configured to interface with an attached device. This can help ensure the device is properly connected both physically and electronically.

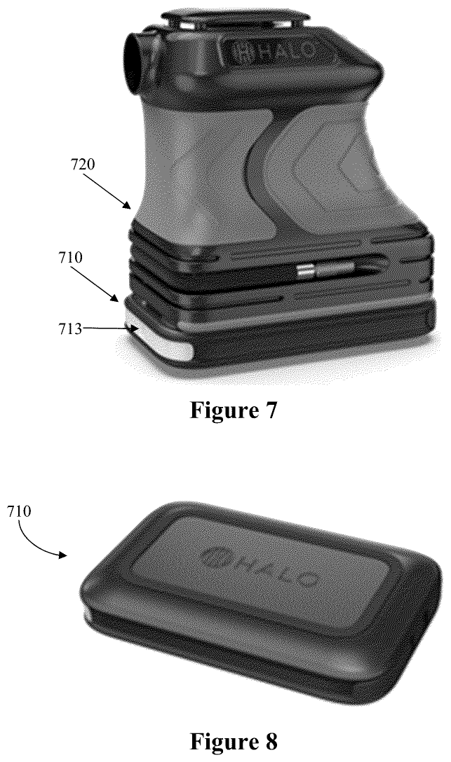

In FIG. 7, a portable power charger 710 (shown separately in FIG. 8) is connected to an air compressor pump 720 using the mechanical attachment means. A status indicator 713 is visible even while the portable power charger 710 is attached. The status indicator 713 is shown as a light-up strip. The status indicator 713 may change color, brightness and/or the amount of the strip being lit to indicate various conditions.

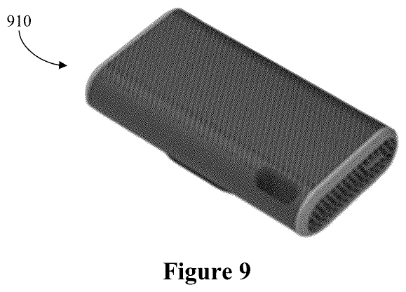

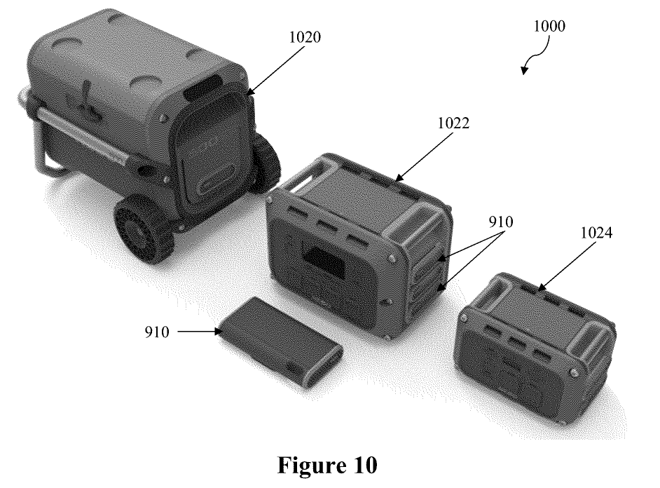

FIG. 9 shows a perspective view of a fourth embodiment of a portable power charger 910. FIG. 10 shows a perspective view of the portable power charger 910 attached to various charging devices 1020, 1022, 1024. The charging devices 1020, 1022, 1024 may be large power batteries capable of holding several times the charge of the portable power charger 910. In other embodiments, the charging devices 1020, 1022, 1024 may also include generators or other recharging means, such as solar panels. Charging devices 1020, 1022, 1024 can also include ports/interfaces for connecting to various power supplies.

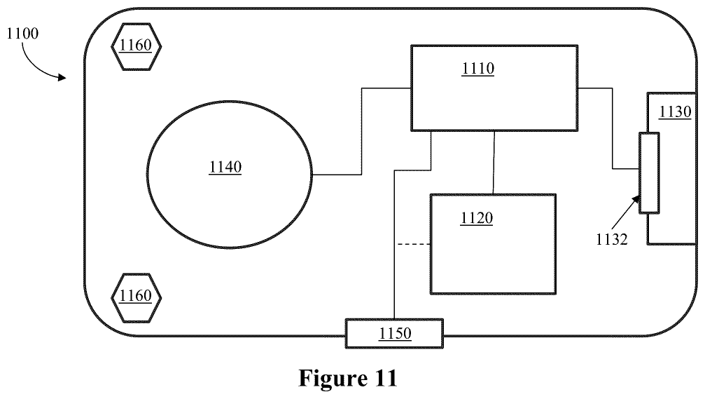

FIG. 11 shows a simplified block diagram of internal components of a fifth embodiment of a portable power charger 1100. The portable power charger 1100 includes a power storage unit 1120, such as a battery, which can be managed via controller 1110. Controller 110 may also control energy transfer to/from ports 1132 and wireless connection 1140. A display 1150 is also provided which can show information regarding the portable power charger 1100 and the power storage unit 1120 specifically. Magnets 1160 are shown which can help ensure connection to an attachment device.

Ports 1132 may be housed within a storage area 1130 capable of holding connector cables. In some embodiments, the connector cables may be directly connected to the ports 1132.

The foregoing description of embodiments has been presented for the purpose of illustration and description. It is not intended to be exhaustive or to limit the invention to the form disclosed. Obvious modifications and variations are possible in light of the above disclosure. The embodiments described were chosen to illustrate the principles of the invention and practical applications thereof to enable one of ordinary skill in the art to utilize the invention in various embodiments and with various modifications as suited to the particular use contemplated. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

What is claimed is:

1. A portable power charger for powering and/or recharging at least one of: a small 12V appliance, and an electronic device having a rechargeable internal battery, said portable power charger unit comprising:
a charger housing internally storing a rechargeable battery, said charger housing having a generally planar first surface having a first area, and first and second sidewalls orthogonally positioned to the first surface;
a wireless transmitter operatively connected to the rechargeable battery capable of wireless transmitting a power to an electronic device attached thereto, said wireless transmitter defining a wireless transmission area; and
first attachment means provided on the charger housing for attaching the charger housing to the one of: the small 12V appliance, and the electronic device, wherein said first attachment means comprise at least one of: grooves and outwardly-directed projections formed in one or more of: the planar first surface, and each of the first and second sidewalls.

2. The portable power charger according to claim 1, further comprising:
at least one power connection interface operatively connected to the rechargeable battery capable of operating as at least one of a power input and a power output,
wherein when said at least one power connection interface operates as a power input, an electrical charge current is provided from an external power source to the portable power charger for recharging the rechargeable battery when the portable power charger is connected to said external power source via said at least one power connection interface, and
wherein when the said at least one power connection interface operates as a power output, a charge is provided from the rechargeable battery of the portable power charger to the small 12V appliance or the electronic device to recharge the rechargeable battery of said small 12V appliance or electronic device when said small 12V appliance or electronic device is connected to the portable power charger via said at least one power connection interface.

3. The portable power charger according to claim 2, wherein said at least one power connection interface comprises at least one of a power connection port and a power connection cable operatively connected to the rechargeable battery.

4. A portable power charger for powering an independent device, said portable power charger comprising:
a charger housing internally storing a rechargeable battery, said charger housing having a generally planar first surface and first and second sidewalls orthogonally positioned to the first surface;
attachment means provided on the first surface of the charger housing for attaching the charger housing to the independent device, wherein said attachment means are formed in the first surface and are adapted to engage complementary-shaped features of the independent device; and
a wireless transmitter operatively connected to the rechargeable battery, the wireless transmitter configured to wirelessly transmit power to the independent device when attached thereto, said wireless transmitter defining a wireless transmission area proximate the first surface of the charger housing.

5. The portable power charger according to claim 4, wherein the portable power charger further comprises: at least one magnet positioned on or near the first surface of the charger housing at a predetermined location relative to the wireless transmission area and adapted for interaction with at least one of: a reciprocal magnet and a metallic piece, so positioned on the independent device such that when said independent device is attached to the portable charger via 1) the magnet in the portable charger, and 2) the reciprocal magnet or metallic piece in the independent device, a wireless receiver in said independent device is aligned with the wireless transmitter in the portable charger.

6. The portable power charger according to claim 4, wherein the attachment means comprise at least one of: grooves and outwardly-directed projections.

7. The portable power charger according to claim 4, further comprising at least one connection port configured to provide power from the rechargeable battery to a device physically connected to the at least one connection port.

8. The portable power charger according to claim 4, further comprising a display configured to indicate a charge level of the rechargeable battery.

9. The portable power charger according to claim 8, wherein the display is at least one LED light.

10. The portable power charger according to claim 4, wherein the charger housing defines a storage space configured to contain at least one connection cable.

11. A portable power charger configured to power an independent device, the portable power charger comprising:
a rechargeable battery;
a housing internally storing the rechargeable battery, the housing having a generally planar first surface and linking structures,
wherein the linking structures are\configured to removably attach the housing to the independent device, and the linking structures are adapted to engage complementary features of the independent device when attached; and
a wireless transmitter operatively connected to the rechargeable battery, the wireless transmitter configured to wirelessly transmit power to a wireless receiver of the independent device when the independent device is attached to the housing.

12. The portable power charger according to claim 11, wherein the wireless transmitter defines a wireless transmission area proximate the first surface of the housing.

13. The portable power charger according to claim 12, wherein the wireless transmitter is further configured to wirelessly transmit power to a wireless receiver of an unattached device when the unattached device is placed on the wireless transmission area.
